(19) United States
(12) Patent Application Publication
(10) Pub. No.: US 2003/0103250 A1
(43) Pub. Date: Jun. 5, 2003

(54) Image reading method, image reading apparatus, image reading system, and image reading program

(76) Inventors: Kazuaki Kidokoro, Yokohama-Shi (JP); Hiroyuki Kato, Ichikawa-Shi (JP); Yoshiko Suenaga, Kawasaki-Shi (JP); Akihiko Fujiwara, Yokohama-Shi (JP)

Correspondence Address: FOLEY AND LARDNER, SUITE 500, 3000 K STREET NW, WASHINGTON, DC, 20007, US

(21) Appl. No.: 09/997,290

(22) Filed: Nov. 30, 2001

(51) Int. Cl. B41J 1/00; H04N 1/04

(52) U.S. Cl. 358/524; 358/474

(57) ABSTRACT

When image data read by a scanner apparatus is to be transferred to and displayed by a simplified portable terminal, the capability such as the size or color depth of an image display area may be lower than that of the scanned image data. If this is the case, the terminal transfers its capability to the scanner apparatus, and the scanner apparatus converts the scanned image data into image data matching the capability of the terminal. The obtained image data is transmitted to and displayed by the terminal. This obviates the need for a user to set complicated parameters on the scanner apparatus. This can also reduce the load of image processing performed by the terminal on image data transmitted from the scanner apparatus.

### BACKGROUND OF THE INVENTION

The present invention relates to an image reading method, image reading apparatus, image reading system, and image reading program and, more particularly, to a method, apparatus, system, and program for reading an image formed on a paper sheet or the like and generating electronic image data.

Recently, large-capacity storage devices and networks are in widespread use, and operations using electronic documents are generally performed. However, paper documents still play important roles even today. On the contrary, with the advancing digitization it is becoming more and more necessary to read information recorded on paper sheets to generate digital data and, e.g., process and save this digital data.

Presently, a scanner apparatus as one example of an image reading apparatus is designed exclusively for a specific user or machine. So, this scanner apparatus is generally occupied by a specific user or connected to a specific machine.

As the need to read an image and obtain digital data increases, however, loading a large number of documents by a plurality of users is increasingly demanded. Therefore, to increase the efficiency of image reading work, it is becoming increasingly popular to connect a high-speed, high-performance scanner apparatus to a network and share this scanner apparatus by a plurality of users using their client terminal devices. In this form of use, a scanner apparatus is shared by a number of client terminal devices, and each client terminal device has various functions and processing capabilities pertaining to image display.

For example, a PDA (Personal Digital Assistant) and a simplified terminal, of a portable telephone or the like, having an image display function are extensively used as terminal devices for receiving and displaying images, although their image display capabilities are lower than regular computers.

Also, as a transmission path for connecting a scanner apparatus and a client terminal device, not only a conventional wired network but also a wireless network such as a relatively-low-speed infrared or radio LAN, e.g., bluetooth, are used.

When a client terminal device having a low image display capability is connected to a scanner apparatus via a relatively-low-speed transmission path, the performance is limited by the ability of the terminal device and the transmission rate of the transmission path. Hence, in some cases the process of transmitting image data read by the scanner apparatus directly to the terminal device is impossible or requires an enormous time.

In cases like this, the conventional approach by the user of the client terminal device is to select an appropriate low resolution or sets a small color depth, when setting various parameters necessary for the scanner apparatus to read images. Unfortunately, the adjustment of these parameters for image read requires knowledge and experience concerning image reading processes. This makes user's operation complicated and difficult.

Additionally, it is difficult to obtain image data matching the client terminal device only by adjusting the individual parameters when the scanner apparatus scans an image. So, image processing is sometimes necessary in the terminal device after image data is given. Accordingly, a simplified terminal device having no image processing capability required to perform post-processing for read images cannot properly display images because the post-processing is difficult to perform.

### SUMMARY OF THE INVENTION

It is an object of the present invention to provide an image reading method, image reading apparatus, image reading system, and image reading program capable of obtaining image data matching a client terminal device with a simple operation.

According to the present invention, there is provided an image reading system comprising a client terminal device which comprises an image display which has predetermined image display capability and displays an image, and a transfer unit for transferring information concerning the capability, and an image reading apparatus which comprises an image processing content determinator for receiving the information concerning the capability transferred from the transfer unit, and determining the capability of the client terminal device, an image reader for reading an image to generate first image data, an image processor for performing, on the first image data, image processing corresponding to the capability determined by the image processing content determinator, and generating second image data, and an image data transfer unit for transferring the second image data to the client terminal device.

According to the present invention, there is provided an image reading system comprising a client terminal device which comprises an image display which has predetermined image display capability and displays an image, and a transfer unit for transferring information concerning the capability and information concerning the transfer destination of first image data, an image processing content determinator for receiving the information concerning the capability transferred from the transfer unit, and determining the capability of the client terminal device, an image reader for reading an image to generate the first image data, an image processor for performing, on the first image data, image processing corresponding to the capability determined by the image processing content determinator, and generating second image data, and an image data transfer unit for transferring the second image data to the client terminal device via a network, and transferring the first image data to the transfer destination of the first image data via the network.

An image reading method of the present invention comprises the steps of, in a client terminal device, transferring information concerning a capability of an image display to an image processing apparatus, in the image processing apparatus, receiving the transferred information concerning the capability, and determining the capability of the client terminal device, reading an image to generate first image data, performing image processing corresponding to the determined capability on the first image data, and generating second image data, transferring the second image data to the client terminal device, and in the client terminal device, receiving the transferred second image data and displaying the image on the image display.

A program for causing a client terminal device and an image processing apparatus to perform processing necessary for image reading according to the present invention causes the client terminal device to transfer information concerning a capability of an image display to the image processing apparatus, the image processing apparatus to determine the capability of the client terminal device by using the transferred information concerning the capability, generate first image data by reading an image, perform image processing corresponding to the determined capability on the first image data, and generating second image data, and transfer the second image data to the client terminal device, and the client terminal device to display an image on the image display by using the transferred second image data.

An image reading program for causing a client terminal device to perform processing necessary for image reading according to the present invention causes the client terminal apparatus to transfer information concerning a capability of an image display to an image processing apparatus, and display an image on the image display by using image data which the image processing apparatus generates by reading an image and performing image processing corresponding to the capability, and transfers to the client terminal device.

An image reading program for causing an image processing apparatus to perform processing necessary for image reading according to the present invention causes the image processing apparatus to determine a capability of a client terminal device by using information which is transferred by the client terminal device and concerns the capability of an image display, generate first image data by reading an image, perform image processing corresponding to the determined capability on the first image data, and generating second image data, and transfer the generated second image data to the client terminal device.

An image reading apparatus of the present invention comprises an image processing content determinator for receiving information concerning a capability of an image display from a client terminal device having the image display, and determining the capability of the client terminal device, an image reader for reading an image to generate first image data, an image processor for performing, on the first image data, image processing corresponding to the capability determined by the image processing content determinator, and generating second image data, and an image data transfer unit for transferring the second image data to the client terminal device.

### BRIEF DESCRIPTION OF THE DRAWINGS

FIG. 1 is a block diagram showing the configurations of an image reading apparatus and image reading system according to an embodiment of the present invention;

FIG. 2 is a flow chart showing an outline of the procedure of an image reading process performed by the image reading system of the embodiment;

FIG. 3 is a view for explaining examples of parameters pertaining to the performance of a client terminal device;

FIG. 4 is a block diagram showing the configuration of an image reading system using a network according to the embodiment of the present invention;

FIG. 5 is a view for explaining an example of a user interface for setting parameters in the image reading apparatus and image reading system according to the embodiment of the present invention; and

FIG. 6 is a flow chart showing the procedure of processing performed by the image reading apparatus and image reading system according to the embodiment of the present invention.

### DESCRIPTION OF THE PREFERRED EMBODIMENT

An embodiment of the present invention will be described below with reference to the accompanying drawings.

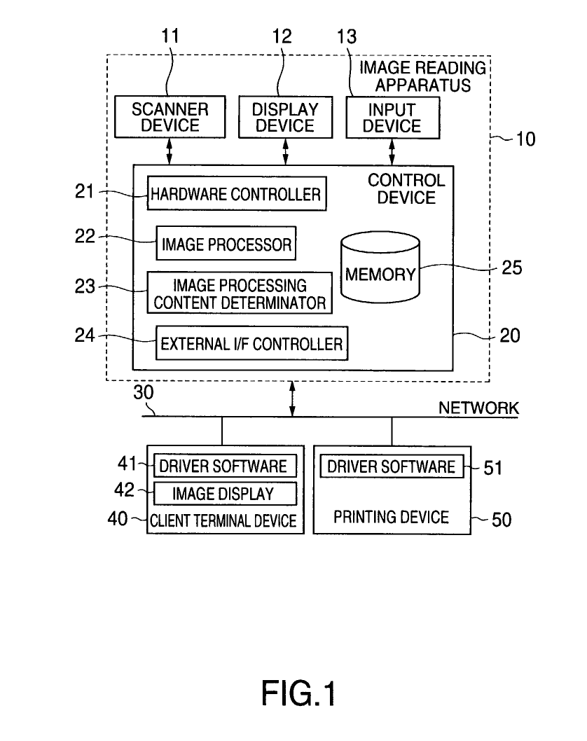

FIG. 1 shows the configurations of an image reading apparatus and image reading system according to the embodiment of the present invention. This system includes an image reading apparatus 10 for generating image data by reading an image and performing predetermined image processing, and a client terminal device 40 for receiving image data from the image reading apparatus 10 and displaying the image. The image reading apparatus 10 and the client terminal device 40 are connected via a network 30.

Also, a printing device 50 is connected to the network 30 as needed. This printing device 50 receives image data from the image reading apparatus 10 and prints out the image.

In the client terminal device 40, driver software 41 for controlling internal operations is stored in an internal memory. Likewise, in the printing device 50, driver software 51 for controlling internal operations is stored in an internal memory. The client terminal device 40 has an image display 42 having a predetermined display capability. This image display 42 receives image data and displays the image. As will be described later, the image display 42 can have various functions and display capabilities; the image display 42 can display only characters, can display not only characters but also graphics and photographs, or can display only monochromatic images.

The image reading apparatus 10 includes a scanner device 11, a display device 12, an input device 13, and a control device 20. This control device 20 has a hardware controller 21, an image processor 22, an image processing content determinator 23, an external interface (I/F) controller 24, and a memory 25.

The scanner device 11 scans characters described on a printing medium such as a paper sheet and/or graphics, tables, pictures, or photographs, and generates scanned data.

The display device 12 and the input device 13 are constructed by, e.g., a touch panel and a simplified keyboard. These display device 12 and input device 13 display the set contents of parameters and the contents of operations on a screen, and accept user inputs.

The hardware controller 21 controls the operations of hardware, i.e., the scanner device 11, the display device 12, and the input device 13.

The image processor 22 performs predetermined image processing for scanned data obtained by the scanner device 11, and generates image data.

The external I/F controller 24 communicates with the driver software 41 contained in the client terminal device 40, and receives an image processing request transmitted from the client terminal device 40, information concerning the performance of the terminal device 40, and the like. This external I/F controller 24 also functions as an image data transfer unit for transferring image data generated by the image processor 22 to the terminal device 40. The external I/F controller 24 thus performs various interface control operations.

The driver software 41 contained in the terminal device 40 has functions such as a function as a transfer unit which transfers information concerning the performance of the terminal device 40 to the control unit 20. The driver software 41 also has a function of receiving image data generated by the image processor 22, and transferring the image data to client application software (not shown) to display the image on the image display 42.

Similarly, the external I/F controller 24 communicates with the driver software 51 contained in the printing device 50 and performs interface control for receiving information pertaining to an image data transfer request transmitted from the printing device 50, and transmitting image data generated by the image processor 22 to the printing device 50.

The driver software 51 contained in the printing device 50 has functions such as a function of transferring an image data transfer request to the image reading apparatus 10, and a function of receiving image data generated by the image processor 22 and transferring the data to client application software (not shown) to print out the image.

Each of the driver software 41 and 51 can also be replaced with a Twain driver used in general image reading apparatuses.

The image processing content determinator 23 communicates with the driver software 41 of the client terminal device 40 via the external I/F controller 24, and determines image processing which the image processor 22 performs for scanned data supplied from the scanner device 11, on the basis of received information indicating the image display capability of the client terminal device 40. In accordance with the processing contents determined by this image processing content determinator 23, the image processor 22 performs the image processing by using the memory 25 to generate image data. The external I/F controller 24 transmits the generated image data to the client terminal device 40.

The image display capability of the client terminal device 40 can be the following. For example, if the client terminal device 40 has only a small monochromatic image display area, the client terminal device 40 cannot display a large color image even when the image reading apparatus 10 transmits the image.

When this is the case, therefore, the image processing content determinator 23 determines the contents of image processing matching the capability of the client terminal device 40. In accordance with the determined contents, the image processor 22 reduces the size of an image scanned by the scanner device 11 such that the image size matches the image pixel size of the display screen of the client terminal device 40. If a scanned image is a color image, the image processor 22 converts the image into a monochromatic image.

In the conventional systems as described earlier, the user sets scanner control parameters such as DPI and color depth for the scanner device. However, it is difficult for general users to set these scanner control parameters such that they suit the client terminal device. Even if such scanner control parameters are set, it is difficult to obtain image data matching the performance of the client terminal device from the scanner device. Accordingly, the client terminal device must convert output image data from the scanner device into a desired format.

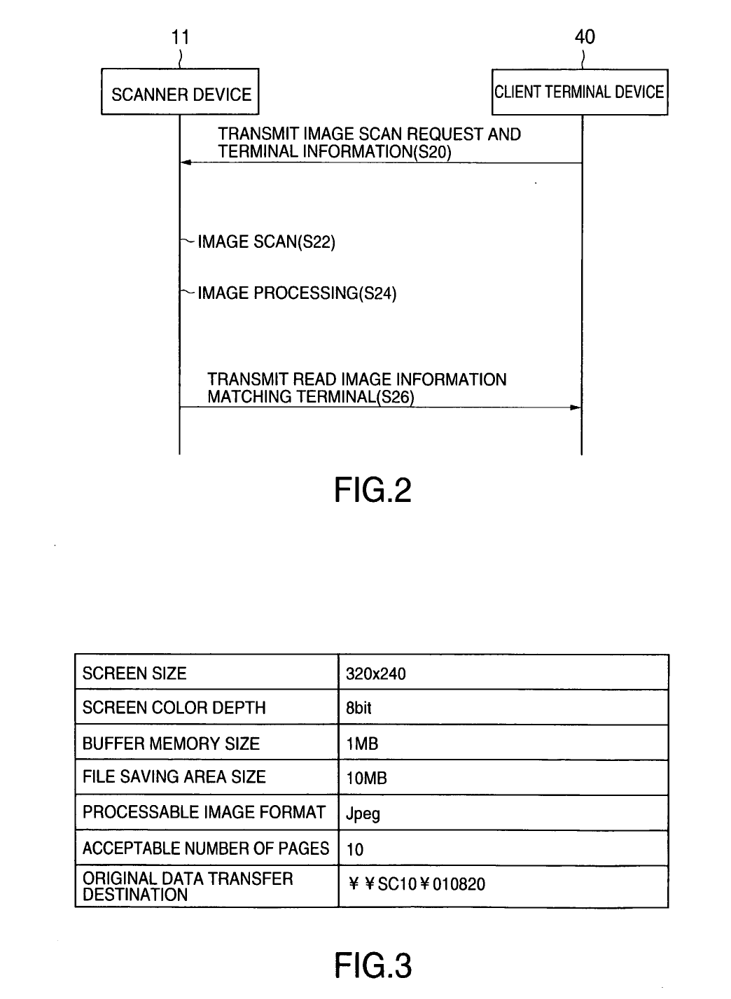

The image reading apparatus and image reading system of this embodiment having the above configurations eliminate this problem. FIG. 2 shows an outline of the procedure of processing performed by this system.

In step S20, the client terminal device 40 issues an image scan request to the scanner device 11. Additionally, the client terminal device 40 transfers information indicating the image display capability, as information pertaining to the client terminal device 40, to the scanner device 40.

In step S22, the scanner device 11 scans an original to obtain scanned data. This original image data normally has a high resolution, a large color depth, and a large capacity.

In step S24, the ability of the client terminal device 40 is checked on the basis of the information indicating the image display capability. The original image data is converted to meet this ability, thereby generating image data for the client terminal device 40.

In step S26, the image data is transferred to the client terminal device 40.

FIG. 3 shows an example of that information indicating the image display capability of the client terminal device 40, which is transferred from the client terminal device 40 to the scanner device 11.

Parameters are the screen size, the screen color depth (1 bit for a monochromatic screen and, e.g., 8 bits (256 colors), 16 bits (65,536 colors), or 24 bits (16,777,216 colors) for a color screen), the size (the capacity of one page) of a buffer memory, the size of an area capable of saving files (the capacity of a memory capable of saving image data), the format (e.g., a compression standard such as Jpeg) of a processable image, the acceptable number of pages (the number of pages of files), and the transfer destination (e.g., a file server) of original image data.

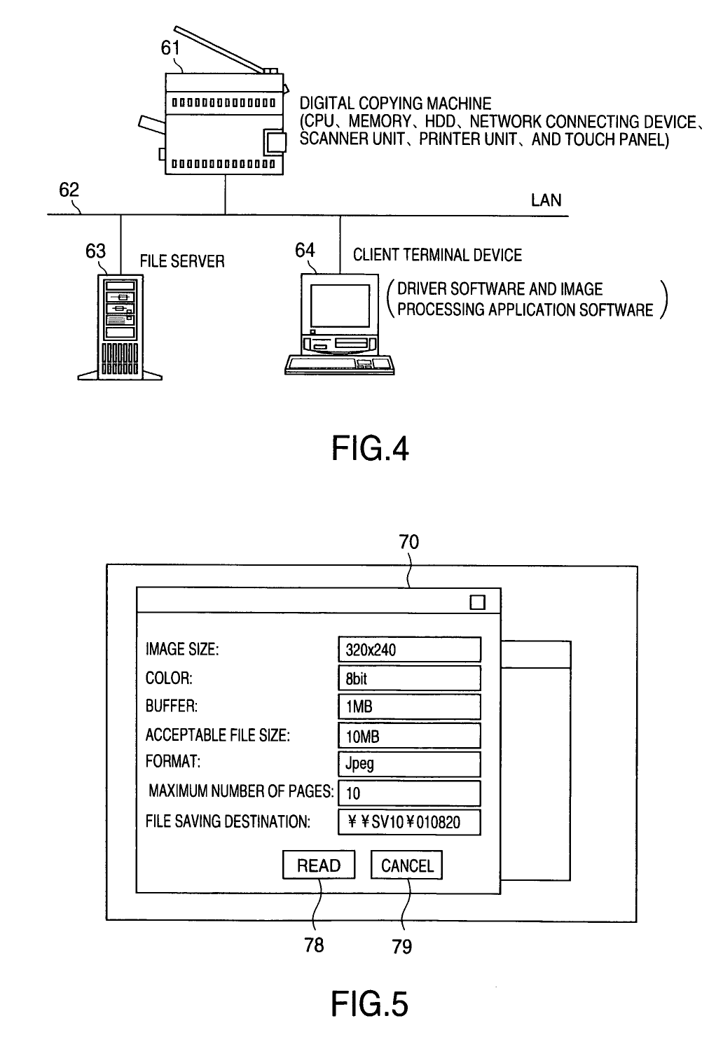

FIG. 4 shows a more practical configuration example of the image reading apparatus and image reading system according to this embodiment shown in FIG. 1.

A digital copying machine 61 having a digital image processing function is used as the image reading apparatus 10, and a client terminal device 64 is connected via a LAN 62.

The digital copying machine 61 has a scanner unit for reading an original by scan, and a printer unit for printing out the read image. This digital copying machine 61 further includes a CPU for controlling the whole operation of the copying machine 61, a memory for storing programs, scanned data, and the like, a hard disk driver (HDD) as an external auxiliary storage device for storing programs and the like, a network connecting device for controlling the connection to the LAN 62, and a touch panel which displays information to the user and has operation keys and the like. The CPU operates by reading out the programs stored in the HDD, thereby controlling the hardware. The scanner unit has a function of reading 600-DPI/24-bit RGB color images.

The client terminal device 64 has driver software, equivalent to the driver software 41 of the client terminal device 40 shown in FIG. 1, which communicates with the digital copying machine 61, and application software for image processing. Referring to FIG. 4, a computer is depicted as an example of this client terminal device 64. However, the client terminal device 64 can be various PDAs and portable telephones, i.e., includes all devices having a function of receiving and displaying image data (which may be character data alone).

A file server 63 receives, via the LAN 62, scanned data which is obtained by the digital copying machine 61 by scanning an original and which generally has a high resolution, a high capacity, and a large color depth, and saves the received data in an internal storage device or an external auxiliary storage device.

The operation of this system is started when the user directly operates the touch panel of the digital copying machine 61, or when the contents set by the user by using the client terminal device 64 are transferred to the digital copying machine 61 via the LAN 62 by driver software of the client terminal device 64.

In this embodiment, driver software for controlling the operations of the scanner unit and image processor of the digital copying machine 61 is installed in the client terminal device 64. The user calls this driver software by operating image processing application software on the client terminal device 64, thereby controlling the digital copying machine.

FIG. 5 shows an example of the user interface of the touch panel of the digital copying machine 61 or of the display and operation unit of the client terminal device 64. This interface sets the various parameters explained with reference to FIG. 3 and includes a button 78 for designating read and a button 79 for canceling the read designation.

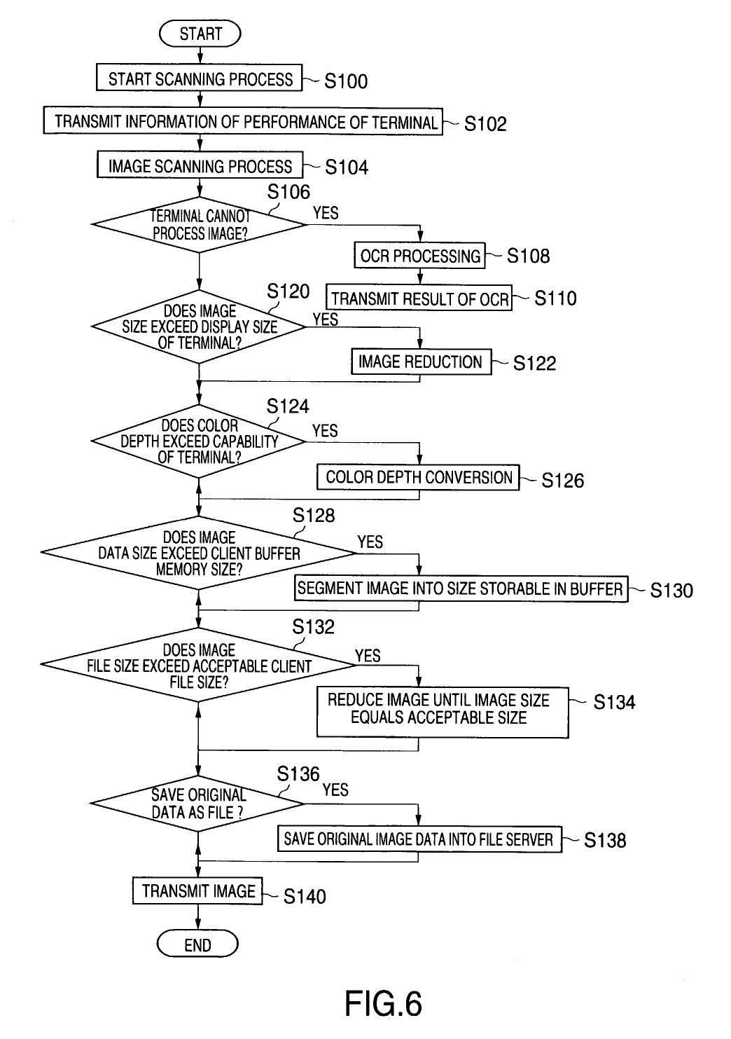

The procedure of the image loading process according to this embodiment will be explained below with reference to a flow chart in FIG. 6.

In step S100, the image processing application of the client terminal device 40 outputs an image scan request. This image scan request is transmitted to the scanner device 11 via the driver software 41 contained in the client terminal device 40, the network 30, and the external I/F controller 24 of the image reading apparatus 10. Consequently, a session for image reading in the scanner device 11 is activated.

A protocol which communicates with the client terminal device 40 via the external I/F controller 24 is not restricted. For example, the Twain protocol which is generally, widely used as a scanner I/F can be used on the TCP/IP protocol on Ethernet.

When a portable terminal is used as the client terminal device 40, not only a cable network but also a radio LAN or a ratio communication path such as Bluetooth can be used as the network 30.

In step S102, the client terminal device 40 transmits to the scanner device 11 terminal information together with scanner operation parameters defined by, e.g., the Twain protocol. This terminal information includes at least information indicating the image display capability of the client terminal device 40. The terminal information is first collected by the driver software 41 of the client terminal device 40, and then transmitted as extended data of, e.g., the Twain protocol, to the scanner device 11.

The information indicating the image display capability has contents, such as shown in FIG. 3, displayed by the user interface of the client terminal device 40. Pieces of information such as the screen size and color depth are set to numerical values corresponding to the ability of the client terminal device 40 in advance, and automatically collected by the driver software 41. However, the user can also change these parameters to desired values.

In step S104, the scanner device 11 reads an original by scan in accordance with read parameters designated by, e.g., the Twain protocol. On the basis of the terminal information transmitted from the client terminal device 40, the image processing content determinator 23 determines the image processing contents of the scanned data. The image processor 22 performs image processing from step S106.

Instep S106, the image processing content determinator 23 checks on the basis of the terminal information whether the client terminal device 40 has the ability to display an image. If the image processing content determinator 23 determines that the client terminal device 40 has no image display capability and can display only character information, the flow advances to step S108. In step S108, OCR processing is performed for the scanned image data by using an OCR module incorporated into the scanner device 11 or an OCR processor (not shown), separated from the scanner device 11, for performing OCR processing. In step S110, character data obtained by this OCR processing is transmitted to the client terminal device 40.

If the image processing content determinator 23 determines that the client terminal device 40 has image display capability, the flow advances to step S120. In step S120, the image processing content determinator 23 checks whether the scanned image size exceeds the display size of the client terminal device 40. If the image processing content determinator 23 determines that the scanned image size exceeds the display size of the client terminal device 40, the flow advances to step S122 to reduce the image.

In the example shown in FIGS. 3 and 5, the size of the display area of the client terminal device 40 is 320×240 pixels. Therefore, if the scanned image size is larger than this size, the resolution is lowered by reducing the scanned image to 320×240 pixels.

If in step S120 the image processing content determinator 23 determines that the scanned image size does not exceed the display size of the client terminal device 40, or if the reducing process in step S122 is complete, the flow advances to step S124. In step S124, the image processing content determinator 23 checks whether the color depth of the scanned image exceeds the color depth of the client terminal device 40. If the image processing content determinator 23 determines that the color depth of the client terminal device 40 is lower than the color depth of the scanned image, the flow advances to step S126 to perform a conversion process for lowering the color depth or a color conversion process for converting into a monochromatic image having a depth of 1 bit.

In the example shown in FIGS. 3 and 5, the terminal has only a color depth of 8 bits. Therefore, if the color depth of the scanned image is, e.g., 24-bit RGB, the process of converting this image data into a color depth of 8 bits is performed.

If in step S124 the image processing content determinator 23 determines that the color depth of the scanned image does not exceed the color depth of the client terminal device 40, or if the color conversion process in step S126 is complete, the flow advances to step S128.

In step S128, the image processing content determinator 23 checks whether the data size of the scanned data exceeds the size of the buffer memory of the client terminal device 40. If YES in step S128, the flow advances to step S130 to segment the scanned image into a plurality of regions. When the image is thus segmented into a plurality of regions, regions from the first region to a region which can be expanded on the buffer memory of the client terminal device 40 are extracted.

If in step S128 the image processing content determinator 23 determines that the data size of the scanned image does not exceed the size of the buffer memory of the client terminal device 40, or if the process in step S130 is complete, the flow advances to step S132.

In step S132, the image data is converted into the designated format (Jpeg in the example shown in FIGS. 3 and 5). The image processing content determinator 23 checks whether the file size of the converted image data exceeds the acceptable file size of the client terminal device 40. If YES in step S132, the flow advances to step S134 to reduce the image data until the file size of the data equals the acceptable size.

If in step S132 the image processing content determinator 23 determines that the file size of the image data does not exceed the acceptable file size of the client terminal device 40, or if the process instep S134 is complete, the flow advances to step S136.

If saving of the original image data is designated, the flow advances to step S138, and the original image data is transferred to and saved in the designated destination. In the example shown in FIGS. 3 and 5, the original image data is transferred to and saved in a file server designated by the address “¥¥SC10¥010820”.

In step S140, the obtained final image data is transferred from the image reading apparatus 10 to the client terminal device 40.

In the above embodiment, it is possible to simplify the user processing when an image reading operation is performed, and automatically obtain a desired image. Hence, post-processing for the read image on the client terminal can be omitted.

The above embodiment is merely an example and can be variously modified within the technical scope of the present invention. For example, the image display capability of the client terminal device shown in FIGS. 3 and 5 is not limited to these contents.

What is claimed is:

1. An image reading system comprising:
a client terminal device which comprises
an image display which has predetermined image display capability and displays an image, and
a transfer unit for transferring information concerning the capability; and
an image reading apparatus which comprises
an image processing content determinator for receiving the information concerning the capability transferred from said transfer unit, and determining the capability of said client terminal device,
an image reader for reading an image to generate first image data,
an image processor for performing, on the first image data, image processing corresponding to the capability determined by said image processing content determinator, and generating second image data, and
an image data transfer unit for transferring the second image data to said client terminal device.

2. A system according to claim 1, wherein
said client terminal device transfers, to said image reading apparatus, information concerning an image size of said image display as the information concerning the capability, and
said image reading apparatus generates the second image data by enlarging or reducing the first image data in accordance with the information.

3. A system according to claim 1, wherein
said client terminal device transfers, to said image reading apparatus, information indicating whether said image display is a monochromatic display or color display and, if said image display is a color display, information concerning color depth, as the information concerning the capability, and
said image reading apparatus generates the second image data by performing, on the first image data, color/monochromatic conversion and, if said image display is a color display, color depth conversion, in accordance with the information.

4. A system according to claim 1, wherein
said client terminal device transfers, to said image reading apparatus, information concerning the capacity of a buffer memory of said image display, as the information concerning the capability, and
said image reading apparatus generates the second image data by performing, on the first image data, processing corresponding to the capacity of said buffer memory in accordance with the information.

5. A system according to claim 1, wherein
said client terminal device transfers, to said image reading apparatus, information concerning a file size of image data in said image display, as the information concerning the capability, and
said image reading apparatus generates the second image data by performing, on the first image data, processing corresponding to the file size in accordance with the information.

6. A system according to claim 1, wherein
said client terminal device transfers, to said image reading apparatus, information indicating whether said image display can display information other than characters, as the information concerning the capability, and
if the information indicates that said image display cannot display information other than characters, said image reading apparatus performs OCR processing for the first image data and generates character information as the second image data.

7. An image reading system comprising:
a client terminal device which comprises
an image display which has predetermined image display capability and displays an image, and
a transfer unit for transferring information concerning the capability and information concerning a transfer destination of first image data;
an image processing content determinator for receiving the information concerning the capability transferred from said transfer unit, and determining the capability of said client terminal device;
an image reader for reading an image to generate the first image data;
an image processor for performing, on the first image data, image processing corresponding to the capability determined by said image processing content determinator, and generating second image data; and
an image data transfer unit for transferring the second image data to said client terminal device via a network, and transferring the first image data to the transfer destination of the first image data via said network.

8. An image reading method comprising the steps of:
in a client terminal device,
transferring information concerning a capability of an image display to an image processing apparatus;
in said image processing apparatus,
receiving the transferred information concerning the capability, and determining the capability of said client terminal device;
reading an image to generate first image data, performing image processing corresponding to the determined capability on the first image data, and generating second image data;
transferring the second image data to said client terminal device; and
in said client terminal device,
receiving the transferred second image data and displaying the image on said image display.

9. A method according to claim 8, wherein
the step of transferring information concerning the capability comprises transferring, to said image reading apparatus, information concerning an image size of said image display as the information concerning the capability, and
the step of generating the second image data comprises generating the second image data by enlarging or reducing the first image data in accordance with the information.

10. A method according to claim 8, wherein
the step of transferring information concerning the capability comprises transferring, to said image reading apparatus, information indicating whether said image display is a monochromatic display or color display and, if said image display is a color display, information concerning color depth, as the information concerning the capability, and
the step of generating the second image data comprises generating the second image data by performing, on the first image data, color/monochromatic conversion and, if said image display is a color display, color depth conversion, in accordance with the information.

11. A method according to claim 8, wherein
the step of transferring information concerning the capability comprises transferring, to said image reading apparatus, information concerning the capacity of a buffer memory of said image display, as the information concerning the capability, and
the step of generating the second image data comprises generating the second image data by performing, on the first image data, processing corresponding to the capacity of said buffer memory in accordance with the information.

12. A method according to claim 8, wherein
the step of transferring information concerning the capability comprises transferring, to said image reading apparatus, information concerning the file size of image data in said image display, as the information concerning the capability, and
the step of generating the second image data comprises generating the second image data by performing, on the first image data, processing corresponding to the file size in accordance with the information.

13. A method according to claim 8, wherein
the step of transferring information concerning the capability comprises transferring, to said image reading apparatus, information indicating whether said image display can display information other than characters, as the information concerning the capability, and
if the information indicates that said image display cannot display information other than characters, the step of generating the second image data comprises performing OCR processing for the first image data and generating character information as the second image data.

14. A program for causing a client terminal device and an image processing apparatus to perform processing necessary for image reading, which causes:
said client terminal device to
transfer information concerning a capability of an image display to said image processing apparatus;
said image processing apparatus to
determine the capability of said client terminal device by using the transferred information concerning the capability;
generate first image data by reading an image, perform image processing corresponding to the determined capability for the first image data, and generating second image data; and
transfer the second image data to said client terminal device; and
said client terminal device to
display an image on said image display by using the transferred second image data.

15. An image reading program for causing a client terminal device to perform processing necessary for image reading, which causes said client terminal apparatus to:
transfer information concerning a capability of an image display to an image processing apparatus; and
display an image on said image display by using image data which said image processing apparatus generates by reading an image and performing image processing corresponding to the capability, and transfers to said client terminal device.

16. An image reading program for causing an image processing apparatus to perform processing necessary for image reading, which causes said image processing apparatus to:
determine a capability of a client terminal device by using information which is transferred by said client terminal device and concerns the capability of an image display;
generate first image data by reading an image, perform image processing corresponding to the determined capability on the first image data, and generating second image data; and
transfer the generated second image data to said client terminal device.

17. An image reading apparatus comprising:
an image processing content determinator for receiving information concerning a capability of an image display from a client terminal device having said image display, and determining the capability of said client terminal device;
an image reader for reading an image to generate first image data;
an image processor for performing, on the first image data, image processing corresponding to the capability determined by said image processing content determinator, and generating second image data; and
an image data transfer unit for transferring the second image data to said client terminal device.
